(19) United States
(12) Patent Application Publication
(10) Pub. No.: US 2015/0178451 A1
(43) Pub. Date: Jun. 25, 2015

(54) SYSTEM AND METHOD FOR HOSPITAL PERFORMANCE MEASURES

(71) Applicant: GENERAL ELECTRIC COMPANY, Schenectady, NY (US)

(72) Inventors: Robert Lee Wallace, Glen Allen, VA (US); Christopher S. Johnson, Richmond, VA (US)

(73) Assignee: GENERAL ELECTRIC COMPANY, Schenectady, NY (US)

(21) Appl. No.: 14/140,039

(22) Filed: Dec. 24, 2013

(51) Int. Cl. G06F 19/00

(52) U.S. Cl. CPC G06F 19/327

(57) ABSTRACT

A system and method for analyzing performance of a health care facility is provided. The system and method includes accessing performance data for a plurality of performance parameters for the health care facility. The system and method also includes calculating a performance value for each performance parameter of the plurality of performance parameters. The system and method further includes calculating an overall performance value for the healthcare facility based on all of the performance values for the plurality of performance parameters. The system and method still further includes providing an indication of the overall performance value.

### BACKGROUND

The subject matter disclosed herein relates generally to the field of health care, and more particularly to systems and methods for providing hospital performance measures.

Operations of hospitals and other health care facilities (e.g., clinics, imaging centers, cardiology treatment centers, emergency rooms, surgical suites, testing laboratories, etc.) are usually complex. The operations may involve coordinating communications and interactions of a variety of entities, including internal members (e.g., physicians, nurses, technicians, supporting staff, and administrative personnel), suppliers (e.g., suppliers for medical equipments and supplies, and service technicians), customers (e.g., patients), regulators (e.g., U.S. and state government agencies), and other entities (e.g., testing laboratories, imaging facilities, and other hospitals).

Various parameters have been used to measure the performance of the hospitals and other health care facilities, e.g., patient tracking, staff tracking, inpatient bed capacity, ancillary service delays, scheduling of services, asset management, etc. However, these parameters are disparate and typically focus on particular aspects of the hospital performance, making it difficult for hospital managers to have a comprehensive view of the overall hospital performance and to provide efficient and effective solutions.

### BRIEF DESCRIPTION

In accordance with a first embodiment, a computer-implemented method for analyzing performance of a health care facility is provided. The method includes, on a processor-based system, accessing performance data for a plurality of performance parameters for the health care facility. The performance data is accessed from an integrated knowledge base in communication with the processor-based system. The method also includes, on the processor-based system, calculating a performance value for each performance parameter of the plurality of performance parameters. The method further includes, on the processor-based system, calculating an overall performance value for the healthcare facility based on all of the performance values for the plurality of performance parameters. The method still further includes displaying, on a user interface of the processor-based system, an interactive indicator of the overall performance value. Interacting with the indicator displays one or both of recommendations for the overall performance value or effects on the overall performance value associated with implementing the recommendations.

In accordance with a second embodiment, a system for analyzing performance of a health care facility is provided. The system includes a memory structure encoding one or more processor-executable routines, when executed, cause acts to be performed. The acts include accessing performance data for a plurality of performance parameters for the health care facility. The acts also include calculating a performance value for each performance parameter of the plurality of performance parameters. The acts further include calculating an overall performance value for the healthcare facility based on all of the performance values for the plurality of performance parameters. The acts still further include providing an indication of the overall performance value. The system also includes a processing component configured to access and execute the one or more routines encoded by the memory structure.

In accordance with a third embodiment, one or more non-transitory computer-readable media encoding one or more processor-executable routines is provided. The one or more routines, when executed by a processor, cause acts to be performed. The acts include accessing performance data for a plurality of performance parameters for a health care facility. The acts also include calculating a performance value for each performance parameter of the plurality of performance parameters. The acts further include calculating an overall performance value for the healthcare facility based on all of the performance values for the plurality of performance parameters. The acts still further include providing an indication of the overall performance value.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of an embodiment of a hospital performance measuring system;

FIG. 2 is a diagrammatical overview of an embodiment of a data mining system for creation of an integrated knowledge base (IKB) for use in measuring hospital performance;

FIG. 3 is a graphical representation of an embodiment of an graphical indicator representative of an overall performance value;

FIG. 4 is a graphical representation of another embodiment of an graphical indicator representative of an overall performance value;

FIG. 5 is a graphical representation of an embodiment of a user interface displaying an overall performance value and information related to one or more of performance parameters;

FIG. 6 is a process flow diagram of an embodiment of a method for measuring hospital performance; and

FIG. 7 is a diagrammatical overview of an embodiment of a computer system for measuring hospital performance.

### DETAILED DESCRIPTION

While the following discussion is generally provided in the context of a hospital, it should be appreciated that the present techniques are not limited to use in the context of a hospital. Indeed, the provision of examples and explanations in the context of a hospital is only to facilitate explanation by providing instances of real-world implementations and applications. However, the present approaches may also be utilized in other contexts, such as other health care facilities (e.g., clinics, imaging centers, cardiology treatment centers, emergency rooms, surgical suites, testing laboratories, etc.), transportation service facilities (e.g., bus stations, train stations, airports, etc.), industrial facilities (e.g., factories, etc), and consumer service facilities (e.g., shopping centers, department stores, etc).

As noted above, various performance parameters may be used to measure a hospital's performance in specific aspects of the hospital's operations. Such performance parameters may include, for example, asset management, medical product logistics, throughput logistics, patient acuity, staff tracking and scheduling, patient tracking, real time location services, bed occupancy rates, mortality rates, revenues, etc. One or more of the performance parameters may be considered together to measure the hospital performance in one major area, and all of the performance parameters may be considered together to measure the overall hospital performance. For example, major areas for hospital performance may include the business performance, quality of care, utilization and efficiency, consumer satisfaction, financial performance, or the like. If the business performance is to be measured, one may consider performance parameters such as asset management, transport management, patient tracking, staff tracking, hand hygiene, etc. If the quality of care is to be measured, one may consider performance parameters such as hospital level mortality, readmission rates, rates of specific medical errors, pre-term birth rate, survival rates for specific cancers, etc. If the utilization and efficiency is to be measured, one may consider parameters such as length of inpatient stay, readmission rates, bed usage rate, etc. If the consumer satisfaction is to be measured, one may consider parameters such as patient's communication with physicians and nurses, responsiveness of hospital staff, cleanliness of hospital environment, willingness to recommend this hospital, etc. If the financial performance is to be measured, one may consider parameters such as revenues, expenses, margin, days in accounts receivable, day's cash on hand, etc.

Some of the performance parameters may be substantially pertinent to only one major area of the hospital performance (e.g., responsiveness of hospital staff is substantially pertinent only to the consumer satisfaction). Some of the performance parameters may be pertinent to more than one major area of the hospital performance (e.g., readmission rates are pertinent to both the quality of care and the utilization and efficiency). As described above, the scope of the hospital measure may be narrow (e.g., limited to one performance parameters for measuring one aspect of hospital performance), broad (e.g., including all performance parameters for measuring the overall hospital performance), or somewhere in between (e.g., including a group of one or more performance parameters for measuring one major area of hospital performance).

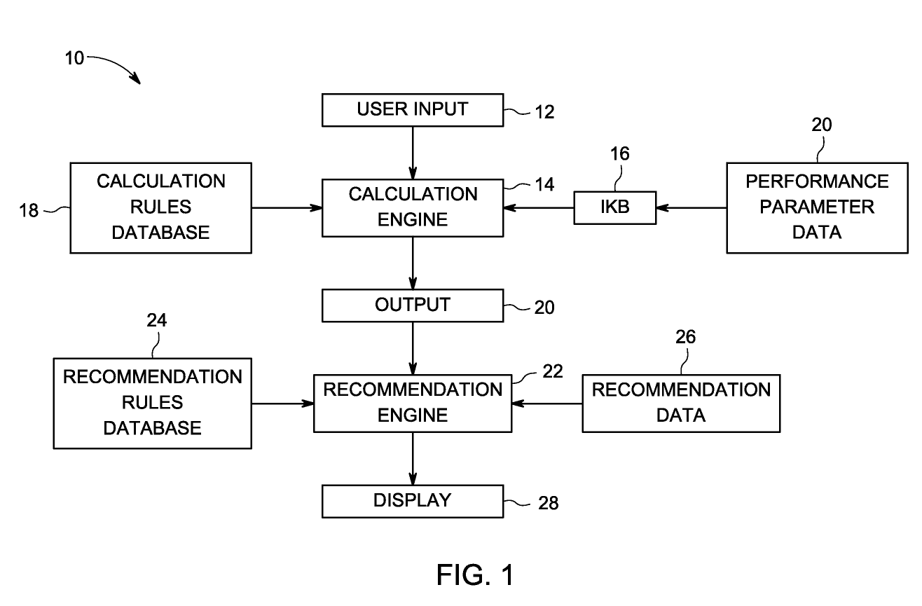

With the foregoing in mind and turning to the drawings, FIG. 1 diagrammatically illustrates a hospital performance measuring system 10, which may be implemented on one or more processor-based systems executing instructions or code encoding routines for implementing the various steps and algorithms discussed herein. In such a processor-based system, such processor-executable instructions or code, as well as data to be analyzed as part of the execution of such code, may be stored on suitable memory or storage structures accessible to the processor, either within the system itself or over a network connection. Further, inputs and outputs as discussed herein may be provided to or by the system via suitable I/O devices, such as keyboards, mice, touchscreens, displays, printers and so forth.

The system 10 may begin with a user input 12 by a user (e.g., a hospital manager). Via the user input 12, the user may define a scope of a hospital measure by selecting one or more performance parameters from a list of all available performance parameters. As noted above, the scope of the hospital measure may be narrow (e.g., when the user selects one or few performance parameters), broad (e.g., when the user selects all performance parameters), or anywhere in between (e.g., when the user selects a group of performance parameters that is a part of one major area of performance. One or more performance parameters may be pre-grouped together with an identifying tag (e.g., “all parameters for business performance” denoting all the performance parameters that are pertinent to the business performance of the hospital, “all parameters” denoting all the available performance parameters, etc), and the user may click on the identifying tag to include all the associated performance parameters. As discussed above, the pre-grouped performance parameters may include the parameters pertinent to the business performance, the quality of care, the utilization and efficiency, the consumer satisfaction, the financial performance, or the overall performance.

Once the performance measure has been set (e.g., the scope of the performance measure has been defined), it may be passed to a calculation engine 14. The calculation engine 14 may include hardware and/or software for drawing upon resources, such as one or more performance parameters (as discussed in greater detail below) that may be compiled in an integrated knowledge base (IKB) 16, as well as upon specific calculation rules in a calculation rules database 18, to calculate an overall hospital performance value. In some embodiments, the overall hospital performance value may be the value representative of the hospital performance that takes into account all the available performance parameters. In certain embodiments, the overall hospital performance value may be the value representative of the hospital performance that takes into account a part of all the available performance parameters (e.g., performance parameters pertinent to one or more major area of performance). As discussed below, the calculation engine 14 may also calculate performance values for individual performance parameters, such as asset management, patient tracking, transport management, etc. The calculation engine 14 may perform such calculation based upon any suitable type and structure of processing, such as neural networks, linear programming, or other processing techniques. In certain embodiments, the overall hospital performance value may be a weighted average value of the performance values for the one or more performance parameters. In other words, certain performance parameters may be given more weight than other performance parameters.

As described in greater detail below, the IKB 16 may be considered to include one or more knowledge bases, relational databases or any other data structure or associated data which compiles any data 20 related to one or more performance parameters. As noted above, the performance parameters may be indicative of how the hospital performed in a specific aspect. All the performance parameters may be complied in the IKB 16. The data 20 related to each performance parameter may include a description of the performance parameter, such as when and how the performance is measured, which group of people (e.g., patients, physicians, staff, etc) is targeted, what time period does the data cover, and so forth. In addition, the data 20 related to each performance parameter may include the relationship between the performance parameter and the hospital performance measure. For example, the hospital readmission rates, as a performance parameter, may be pertinent to both the quality of care and the utilization and efficiency of the hospital, and accordingly, may be labeled with two tags, one for the quality of care, and the other for the utilization and efficiency. Furthermore, the data 20 related to each performance parameter may include an assessment of the performance parameter. For example, the assessment may be a numerical value (e.g., 90 out of 100), a verbal description (e.g., excellent, acceptable, improvement needed, etc), or both. In actual implementation, the IKB 16 may be stored in one or multiple locations, and accessed by the calculation engine 14 locally or remotely.

The calculation engine 14 may also call upon certain rules in the calculation rules database 18 for facilitating the calculation of the overall hospital performance value. A wide range of rules may be implemented, typically including selecting specific performance parameters based on the performance measure and assigning weights to the selected performance parameters. The rules may be programmed by the user (e.g., the hospital manager) and may be adapted depending upon changes in available performance parameters, priorities among performance parameters, and so forth.

Rules selecting specific performance parameters based on the performance measure set via the user input 12 may be implemented in the calculation rules database 18. In some embodiments, based on the performance measure, the performance parameters that are pertinent to the performance measure may be selected for purposes of calculation. For example, if the business performance is selected or set as the performance measure of the hospital via the user input 12, the system may then search through the IKB 16 and select those performance parameters in the IKB 16 with tags representative of the business performance.

In addition, rules assigning a numerical value to the assessment of a performance parameter when the numerical value is lacking with the performance parameter in the IKB 16 may be implemented in the calculation rules database 18. As noted above, in the IKB 16, the assessment of a performance parameter may be verbal only, therefore lacking a numerical value. In such a situation, the rule may assign a numerical value to the performance parameter. For example, if a performance parameter in the IKB 16 is assessed with “good” in a four tier assessment scale (e.g., “excellent,” “good,” “acceptable,” and “failed”), the rule may assign a numerical value of 75 (or other specified value) to the performance parameter. The assignment of the numerical value may be based on the characteristics of the performance parameter (e.g., how many tiers in the assessment scale), the relationship to other similar performance parameters (e.g., how the “good” for this performance parameter is compared to the “good” for another similar performance parameter), historical values (e.g., whether there is a historical numerical score for this performance parameter), or user inputs (e.g., request input from a user). If the performance parameter has an associated numerical value for the assessment, the rule may take that numerical value as input for the calculation engine 14.

Further, rules assigning weights to the performance parameters pertinent to the performance measure to be calculated may be implemented in the calculation rules database 18. A wide range of rules may be implemented for the weight assignment. For example, all the selected performance parameters may be weighed equally, or some performance parameters may be weighed greater than others. The assignment of the weight to each performance parameter may be based on the characteristics of the performance parameter. For example, between the two performance parameters, patient tracking and hand hygiene, patient tracking may be assigned more weight than hand hygiene when the hospital's business performance is measured. In some embodiments, the weight to each performance parameter may be assigned manually by the user (e.g., the hospital manager).

As discussed above, the calculation engine 14 may take the user input 12, call upon the IKB 16 and the calculation rules database 18, and perform the calculation of the overall performance value. In some embodiments, the overall hospital performance value may be a weighted average value of one or more performance parameters. For example, a hospital manage select via the user input 12 the overall performance as the hospital performance measure. In the depicted implementation of the IKB 16, only three performance parameters (e.g., patient tracking, responsiveness of staff, and revenues) are available with performance values of 90, 70, and 50, respectively. The calculation engine 14 may call upon the IKB 16 for these three parameters and their performance values, and call upon the calculation rules database 18 for a weight assignment (e.g., 0.4, 0.5, and 0.1 for the three performance parameters). The calculation engine 14 may then calculate the overall hospital performance as 76 (=90×0.4+70×0.5+50×0.1).

An output 20 of the calculation engine 14 may include the overall performance value, as well as performance values for individual performance parameters. In addition, the output 20 of the calculation engine 14 may include the defined performance measure via the user input 12, as well as the pertinent performance parameters used for calculating the overall performance value by the calculation engine 14. In some embodiments, all or a part of the output 20 may be stored in one or more memory structures. For example, the calculated overall performance value and the defined performance measure may be stored in the memory, but the pertinent performance parameters may be labeled with a tag in the IKB 16 for identification purposes.

A recommendation engine 22, based on the output 20 of the calculation engine 14, provides recommendations (e.g., how to improve the overall hospital performance and/or performance associated with specific parameters) to the user. The recommendation engine 22 may call upon rules in a recommendation rules data base 24, as well as the recommendation data 26.

In the recommendation rules database 14, rules setting one or more threshold values indicative of levels of the hospital performance may be implemented. The overall performance value calculated by the calculation engine 14 and/or individual performance parameters may then be compared with the threshold values by the recommendation engine 22. The same or different threshold values may be set for the overall performance and individual performance parameters. For example, a threshold value of 60 indicative of an acceptable level of performance may be set for the overall hospital performance, a threshold value of 50 for some performance parameters, and a threshold value of 75 for other performance parameters. In certain embodiments, more than one threshold value may be set for the overall hospital performance and/or individual performance parameters. For example, two threshold values of 50 and 80 may be set for the overall hospital performance, thereby indicating three levels of performance, e.g., 0-49, 50-79, and 80-100 indicative of “unacceptable,” “marginally acceptable,” and “acceptable” performance, respectively.

In addition, in the recommendation rules database 14, rules prioritizing multiple performance parameters may also be implemented. A wide range of prioritizing rules may be implemented. For example, prioritizing multiple performance parameters may be based on their performance values. For example, three “unacceptable” performance parameters (e.g., the asset management, the patient tracking, and the hand hygiene) have the performance values of 30, 40, and 50, respectively, the recommendation may provide that concerns with the asset management are addressed first, concerns with the patient tracking second, and concerns with the hand hygiene last (e.g., 30<40<50). In certain embodiments, prioritizing multiple performance parameters may be based on their weights. In the above example, if the three performance parameters have weights of 0.4, 0.5, and 0.1, respectively, the recommendation may provide that concerns with the patient tracking are addressed first, concerns with the asset management second, and concerns with the hand hygiene last (e.g., 0.5>0.4>0.1).

The recommendation engine may also call upon recommendation data 26 for providing recommendations. The recommendation data 26 may include historical records that include previous actions taken for improving the performance with regard to the overall hospital operations, and/or operations in specific aspects (e.g., operations associated with individual performance parameters). The recommendation data 26 may also include opinions, suggestions, and/or comments from people who conduct the performance measurement (e.g., a committee who evaluates the readmission rates), people whom the measurement is targeting (e.g., patients who respond to the satisfaction survey), experts who provide advice and/or suggestions to the hospital operations (e.g., consultants), or the like.

The recommendations provided by the recommendation engine 22, as well as the output 20 may then be provided to the user via a display 28. As discussed in greater detail below, the display 28 may include a graphic indicator representative of the overall performance value. The display 28 may also include a user interface displaying with or without interactions from the user a wide of information, including all pertinent performance parameters, their associated scores, recommendations for improving the overall performance and/or the individual performance parameters.

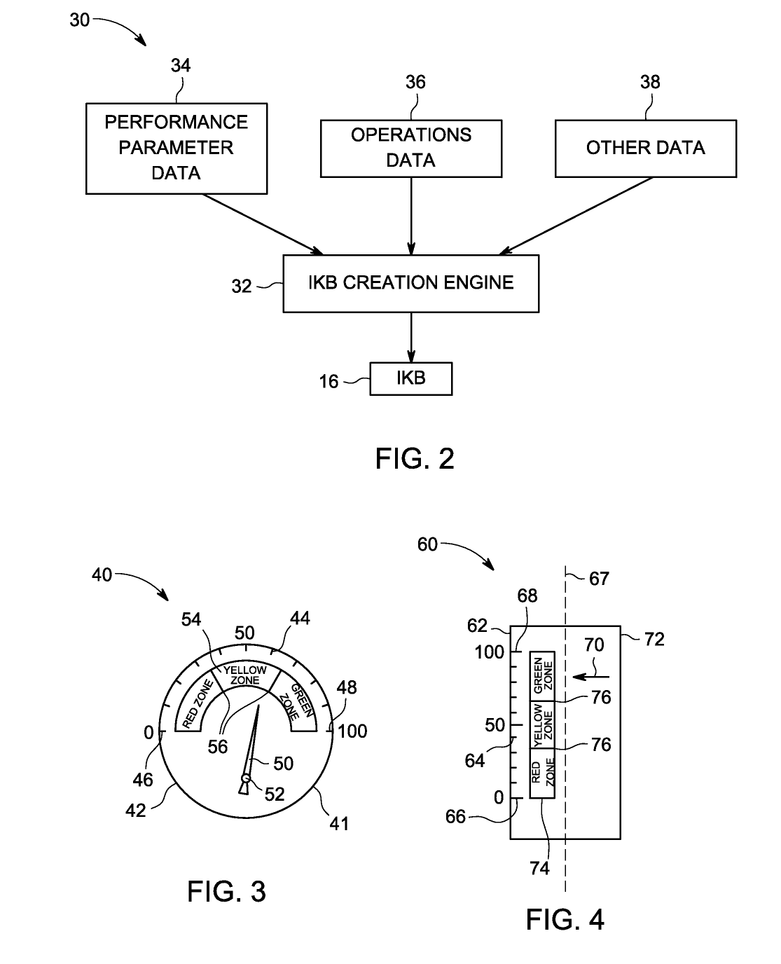

As noted above, various information accessed by the calculation engine 14 and the recommendation engine 22 may be stored in the IKB 16, or may be accessed directly. FIG. 2 illustrates an exemplary overview of an embodiment of a data system 30 for creation of the IKB 16 in accordance with the present implementation.

The data system 30 includes an IKB creation engine 32 that will generally include software and hardware designed to access a range of data and analyze the data to identify parameters, trends, statistical correlations, and so forth. The IKB creation engine 32 may operate on historic records, but may also update the information on a periodic basis as new or supplemental information becomes available. The IKB creation engine 32, in particular, may access information that may be categorized as hospital performance parameters data 34, operations data 36, and other data 38.

The performance parameters, as noted above, may be indicative of how the hospital performed in a specific area that is pertinent to a hospital performance measure. Specifically, the performance parameters may include parameters that are pertinent to the business performance of the hospital, such as the asset management, bed or resource management, environmental services management, transport management, patient tracking, staff tracking, hand hygiene, discharge optimization, automatic patient placement, and service management. In addition, the performance parameters may include parameters that are pertinent to the quality of care for the hospital, such as the hospital-level mortality rates, complication rates, infection rates, rates of specific medical errors, rates for patient safety issues, unexpected return to surgery, survival rates for specific cancers, and childhood immunization rates. Furthermore, the performance parameters may include parameters that are pertinent to the utilization and efficiency of the hospital, such as the bed occupancy rate, length of stay, admissions rate, and cost per discharge. Still, the performance parameters may include parameters that are pertinent to the consumer satisfaction with the hospital, such as patient's satisfaction with regard to the quality of care, communication with physicians and staff, wait time, ease of access, cleanliness of facilities, expected results achieved, parking, food, and other services. Yet still, the performance parameters may include parameters that are pertinent to the financial performance of the hospital, such as revenues, expenses, margin, day's cash on hand, revenue per physician, and pharmacy cost. Finally, the performance parameters may include parameters that are pertinent to other performance measures, such as uncompensated care, Medicaid, free clinical service programs, availability of translation services. It should be noted that the list of the performance parameters provided above are only some of the parameters and not exclusive, and the IKB 16 may include other commonly used or user-defined performance parameters.

As noted above, the performance parameter data 34 for each performance parameter may include a range of information, including the description of the performance parameter (e.g., when and how the performance is measured), the relationship to the hospital performance (e.g., whether is the performance parameter pertinent to a performance measure), and the assessment of the performance parameter (e.g., a numerical score, a verbal assessment).

The IKB creation engine 32 may also access the operation data 36. The operation data 36 may include any information related to the operations of the hospital. Such information may include the physicians' schedules, staff's schedules, patients' schedules, inventories of equipment and supplies, facility and equipment usage, equipment locations, service personnel and schedules, surgeries and procedures, pharmacy, and accounting. The information from the operation data 36 may be analyzed by the IKB engine 32 to measure one or more performance parameters and/or provide supplemental information related to the one or more performance parameters. For example, the patients' schedules and equipment usage may be analyzed in combination to provide information related to the patient tracking. Similarly, the accounting data may be analyzed to provide information related to the revenue, margin, or the like for the financial performance. Some or all of the information may be stored in the IKB itself, or may be stored remotely in various places (e.g., computers, terminals, hard drives, or the like) and accessed remotely by the IKB engine 32.

Various other data 38 may also be considered by the IKB creation engine 32. Such data may be accessed from any suitable resource, and may include information from the electronic medical records, hospital information system, admissions discharge transfer, and predictions regarding the hospital operations. Here again, this information, either alone or in combination with the operation data 36, may be analyzed by the IKB engine 32 to measure one or more performance parameters and/or provide supplemental information related to the one or more performance parameters. For example, the electronic medical records may provide information related to the quality of care, e.g., the mortality rates, readmission rates, etc. Similarly, the predictions regarding the hospital operations may provide information related to a range of the performance parameters in a future time period. Again, some or all of the information may be stored in the IKB itself, or may be stored remotely in various places (e.g., computers, terminals, hard drives, or the like) and accessed remotely by the IKB engine 32.

As discussed above, the overall performance value and the recommendations may be provided to the user via the display 28. FIGS. 3 and 4 illustrate two respective embodiments of graphical indicators 40, 60 representative of the overall performance values.

As shown in FIG. 3, the graphic indicator 40 includes essentially a circle 41, a part of whose circumference 42 is marked with a series of equally spaced marks or tics 44. The marks 44 are representative of numerical values (e.g. 0-100), with a leftmost mark 46 corresponding to a minimum value (e.g., 0), and a rightmost mark 48 corresponding to a maximum value (e.g., 100). As illustrated, each mark 44 corresponds to a value of 10 on the scale of 0 to 100. A graphical representation of needle 50 may freely rotate around a point 52 within the circumference 42, and point to any point along the circumference 42 between the leftmost mark 46 and the rightmost mark 48. That is, where the needle 50 points along the circumference 42 corresponds to a numerical value between 0 to 100 (including 0 and 100), and such numerical value may be representative of the overall performance value calculated by the calculation engine 14. In addition, essentially parallel to and extending along and within the circumference 42, three colored zones 54 (e.g., red, yellow, and green) represent three levels of the performance (e.g., red for “unacceptable”, yellow for “marginally acceptable”, and green for “acceptable”), with two thresholds 56 that separate the adjacent colored zones (e.g., red-yellow and yellow-green).

As noted above, the number of the thresholds 56 and their values may be different depending on the performance measure (e.g., measure of the overall performance, measure of the individual aspects, etc), and may be set or changed in the recommendation rules database 24. Accordingly, the number of the colored zones and their positioning relative to the numerical scale may also be different. For example, only one threshold value of 50 may be set, and two corresponding colored zones (e.g., red for 0-49 and green for 50-100) may indicate the level of the performance (e.g., red for “unacceptable” and green for “acceptable”). Similarly, the numerical scale, the number of marks 44, and the value that each mark 44 represents, may also be different. For example, the numerical scale may be from −10 to 10, and each mark 44 in between may represent a value of 0.5.

FIG. 4 illustrates another embodiment of the graphic indicator 60 that includes essentially a ruler-like rectangle. The left side 62 of the indicator 60 is marked with a series of equally spaced marks 64. The marks 64 are representative of numerical values (e.g. 0-100), with a lowest or bottommost mark 66 (relative to a vertical axis 67 of the indicator 60) corresponding to a minimum value (e.g., 0), and a highest or topmost mark 68 corresponding to a maximum value (e.g., 100). As illustrated, each mark 64 corresponds to a value of 10 on the scale of 0 to 100. An arrow 70 may freely move along the right side 72 of the indicator 60, and point to any point along the left side 62 between the bottommost mark 66 and the topmost mark 68. That is, the vertical location of the arrow 70 relative to the marks 64 corresponds to a numerical value between 0 to 100 (including 0 and 100), and such numerical value may be representative of the overall performance value calculated by the calculation engine 14. In addition, essentially parallel to the left side 72, three colored zones 74 (e.g., red, yellow, and green) represents three levels of the performance (e.g., red for “unacceptable”, yellow for “marginally acceptable”, and green for “acceptable”), with two thresholds 76 that separate the adjacent colored zones (e.g., red-yellow and yellow-green).

Again, the number of the thresholds 76 and their values may be different depending on the performance measure (e.g., measure of the overall performance, measure of the individual aspects, etc), and may be set or changed in the recommendation rules database 24. Accordingly, the number of the colored zones and their positioning relative to the numerical scale may also be different. For example, only one threshold value of 50 may be set, and two corresponding colored zones (e.g., red for 0-49 and green for 50-100) may indicate the level of the performance (e.g., red for “unacceptable” and green for “acceptable”). Similarly, the numerical scale, the number of marks 64, and the value that each mark 64 represents, may also be different. For example, the numerical scale may be from −10 to 10, and each mark 64 in between may represent a value of 0.5.

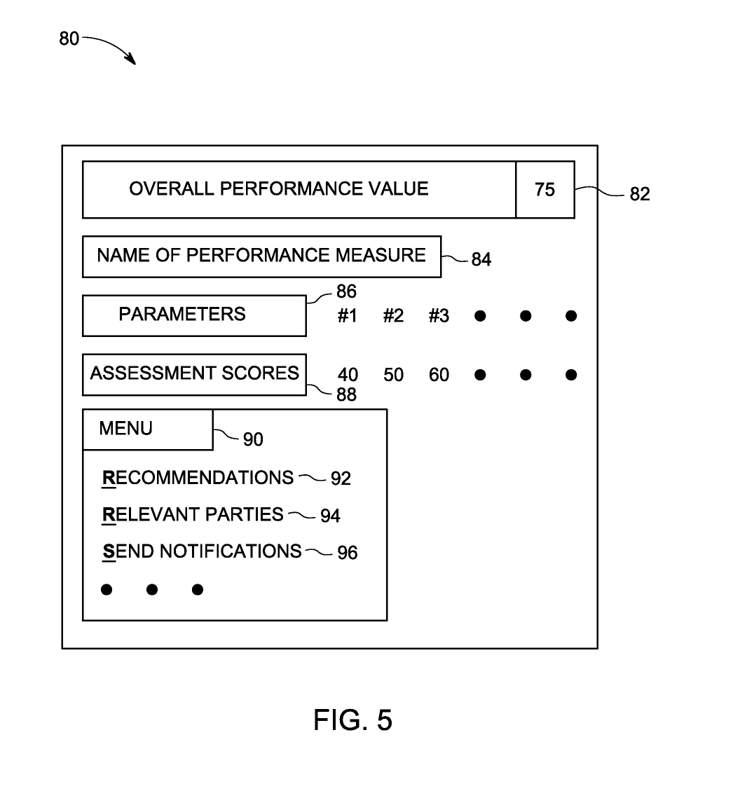

FIG. 5 illustrates an embodiment of a user interface 80 displaying an overall performance value and other related information, including recommendations. The user interface 80 may appear in the display 28 upon clicking a graphic indicator (e.g., the graphic indicators 40, 60 illustrated in FIGS. 3 and 4, respectively) of the overall performance value. The user interface 80 includes a region for displaying the overall performance value 82. In some embodiments, one or more threshold values representative of the level of the performance may also be displayed with the overall performance value 82. In certain embodiments, the overall performance value 82 may be highlighted with a color representative of the level of the performance (e.g., red for “unacceptable”, yellow for “marginally acceptable”, and green for “acceptable”), or may be displayed with such color as a background.

The user interface 80 may also include other related information. As shown in FIG. 5, the name and/or the description of the performance measure 84 (e.g., the overall performance, the performance in one major area, or the performance in a specific aspect) may be displayed. In addition, a part or all of the pertinent performance parameters 86 used for calculating the overall performance value may be listed in the user interface 80. The performance values 88 associated with the performance parameters 86 may also be listed along with the name of the performance parameters 86. Similarly, in some embodiments, one or more threshold values representative of the level of the performance may also be displayed with each performance parameter 86. In certain embodiments, the performance values 88 may be highlighted with a color representative of the level of the performance (e.g., red for “unacceptable”, yellow for “marginally acceptable”, and green for “acceptable”), or may be displayed with such color as a background.

Via user interaction with the user interface 80 by any suitable means (e.g., clicking on the overall performance value 82, clicking on a menu, keyboard entry, voice command, etc), the user interface 80 may also display a menu 80 listing other related information. In some embodiments, the menu 80 may include recommendations 92 associated with the overall performance and/or individual performance parameters. As noted above, the recommendations 92 may be provided by the recommendation engine 22. In certain embodiments, the user interface 80 may also display an updated overall performance value when the user chooses to accept all or a part of the provided recommendations 92. For example, the user may choose to accept the provided recommendations 92 associated with one or more “unacceptable” performance parameters, and the system (via, e.g., the calculation engine 14) may recalculate the overall performance value by re-setting the assessment scores of the one or more “unacceptable” performance parameters to values above their respective thresholds. Relevant parties 94 that may facilitate improving the overall performance value and/or individual performance parameters may also be provided through the menu 90. Such information may be provided by the IKB 16 directly or through the recommendation engine 22 and/or the calculation engine 14. Moreover, the menu 96 may provide options to send notifications and information 96 to the relevant parties. In certain embodiments, a part or all above-discussed information may be provided to user without any user interactions.

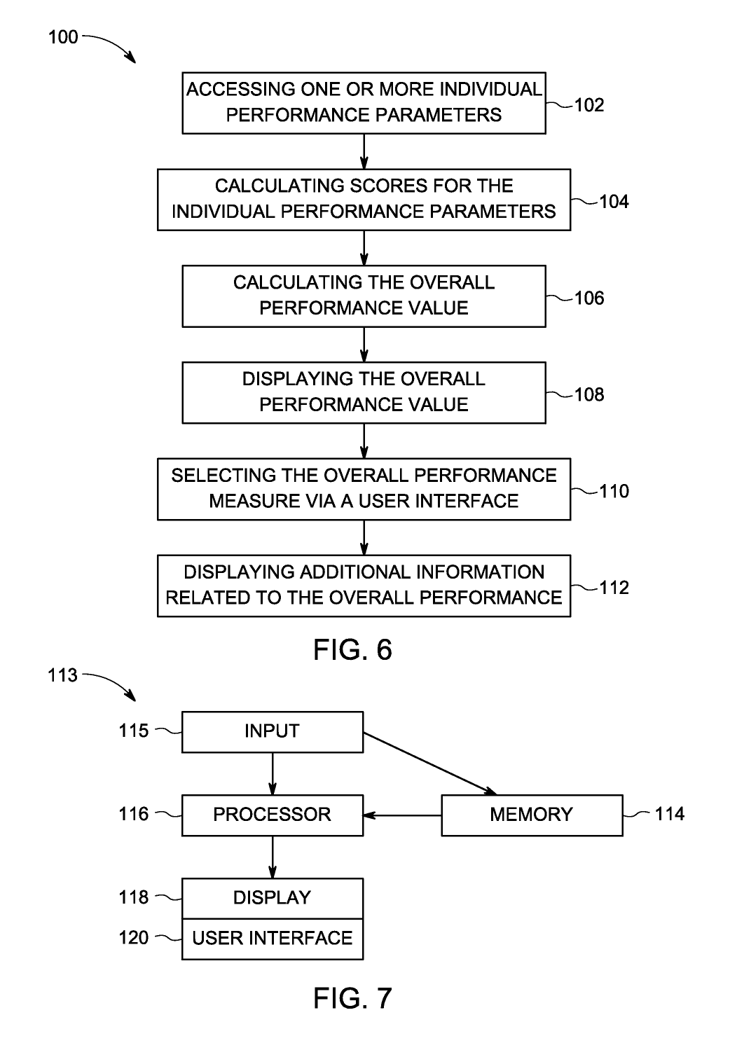

FIG. 6 is a process flow diagram of an embodiment of a method 100 for measuring hospital performance. The method 100 begins with accessing data related to one or more individual performance parameters (step 102). As discussed above, such data may be stored in the IKB 16. The one or more individual performance parameters may be chosen based on the defined performance measure via the user input 12.

Then performance values for the individual performance parameters may be calculated (step 104). As noted above, the individual performance parameter data 20 stored in the IKB 16 may include numerical scores indicative of the assessment of the performance parameters for some performance parameters. In such situations, the performance values may be taken directly from the IKB 16 by the calculation engine 14. In some embodiments, when such numerical score is lacking for a specific performance parameter, the calculation engine 14 may call upon the calculation rules database 18 that may include rules assigning a numerical score for that specific performance parameter.

The calculation engine 14 may then calculate the overall performance value for the hospital (step 106) by calling upon the calculation rules database 18. As noted above, the calculation rules database 18 may include rules assigning weights to individual performance parameters. In some embodiments, the calculation of the overall performance value may be based on the weighted average of the performance parameters.

The output 20 from the calculation engine 14 may be provided to the recommendation engine 22. The recommendation engine 14 may call upon the recommendation rules database 24 and the recommendation data 26 to provide the user recommendations with regard to assessing the overall performance value (e.g., by setting one or more threshold values) and improving the overall hospital performance and/or individual performance parameters. The overall hospital performance value may be provided to the user via the display 28 (step 108). Via the user interface 80, the user may select the overall performance value (step 110), and upon selection, additional related information such as recommendations may also be provided to the user via the display 28 (step 112).

FIG. 7 is a diagrammatical overview of an embodiment of a computer system 113 implementing the described methods. As noted above, in some embodiments, various components of the system 113 may be implemented within one computer. In other embodiments, different components of the system 113 may be implemented on different computers.

An input device 115 of the system 113 may include the user input 12 as in FIG. 1, where the user may select or create the performance measure. The input device 115 may also be used for inputting and/or adapting rules for the calculation rules database 18 and the recommendation rules database 24, and for inputting the performance parameter data 20. The input device 115 may include a keyboard, a mouse, a voice commanding device, a touch screen, a writing pad, or any combination thereof.

The calculation rules database 18, the recommendation rules database 24, and the IKB 16 may be store in one or more memory devices 114. For example, the IKB 16 may include data stored in various memory devices 114 located in various computers. The memory device(s) 114 may include a non-transitory computer-storage medium (e.g., compact disc (CD or magnetic storage medium), DVD, memory stick, random access memory (RAM), random operating memory (ROM), flash memory, EEPROM, etc.) configured to receive, record, and store data and/or instructions.

One or more processors 116 may call upon the one or more memory devices 114 and process the calculation and recommendation. For example, the one or more processors 116 may include the calculation engine 14 and the recommendation engine 22 in FIG. 1. The processor(s) 116 may include one or more microprocessors, such as one or more “general-purpose” microprocessors, one or more special-purpose microprocessors and/or application specific integrated circuits (ASICS), or some combination thereof.

The calculated overall performance value and other related information, such as the recommendation for improving the overall performance and/or individual performance parameters, may then be provided to the user via a display 118. The display may include a user interface 120. Such user interface 120 may include the user interface 80 in FIG. 5.

Technical effects of the disclosed embodiments include providing systems and methods for determining the overall performance value for a hospital. The systems and methods may include calculating assessment values for individual performance parameters and providing recommendations on improving the overall performance value and/or individual performance parameters. The overall performance value provides to a user (e.g., a hospital manager) an organizational holistic view of the hospital performance without going through various disparate performance parameters. The user may also via a user interface access other information related to the hospital performance, such as recommendations for improving the overall hospital performance and/or individual performance parameters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for analyzing performance of a health care facility comprising:
on a processor-based system, accessing performance data for a plurality of performance parameters for the health care facility, wherein the performance data is accessed from an integrated knowledge base in communication with the processor-based system;
on the processor-based system, calculating a performance value for each performance parameter of the plurality of performance parameters;
on the processor-based system, calculating an overall performance value for the healthcare facility based on all of the performance values for the plurality of performance parameters; and
displaying, on a user interface of the processor-based system, an interactive indicator of the overall performance value, wherein interacting with the indicator displays one or both of recommendations for the overall performance value or effects on the overall performance value associated with implementing the recommendations.

2. The method of claim 1, wherein the interactive indicator comprises an indicator of a numerical value for the overall performance value relative to a numerical scale.

3. The method of claim 2, comprising comparing the overall performance value to a threshold indicative of an acceptable overall performance value, and providing an additional indication, via the interactive indicator, of whether the overall performance value is acceptable relative to the threshold.

4. The method of claim 3, wherein the interactive indicator comprises a plurality of colored zones representative of an acceptability of the overall performance value, wherein the plurality of zones comprises a first colored zone representative of an acceptable overall performance value and a second colored zone representative of an unacceptable overall performance value, and wherein the graphical indicator displays the indicator of the numerical value relative to the plurality of colored zones.

5. The method of claim 4, wherein the plurality of zones comprises a third colored zone representative of an intermediate region between the first colored zone and the second colored zone.

6. The method of claim 1, wherein the recommendations are associated with one or more of the performance parameters, and the recommendations are prioritized based on one or more prioritizing rules.

7. The method of claim 1, wherein the recommendations are associated with one or more of the performance parameters, and the recommendations are based on historical records, expert opinions, or surveys, or any combination thereof.

8. The method of claim 1, wherein interacting with the indicator displays information related to one or more of the performance parameters of the plurality of performance parameters.

9. The method of claim 8, wherein the information related to one or more of the performance parameters comprises at least one of numerical values for performance values for one or more of the performance parameters of the plurality of performance parameters, indicators for one or more of the performance parameters of the plurality of operation parameters of whether a respective performance value is acceptable relative to a threshold indicative of an acceptable performance value for the respective performance value, or one or more recommendations to improve the performance values for one or more performance parameters of the plurality of performance parameters.

10. The method of claim 1, comprising comparing the performance value for each performance parameter of the plurality of performance parameters to a respective threshold indicative of an acceptable performance value for a respective performance parameter.

11. The method of claim 1, wherein the plurality of performance parameters comprises at least two of asset management, medical product logistics, bed management, environmental services management, transport management, patient tracking throughput logistics, patient acuity, staff tracking and scheduling, hand hygiene, discharge optimization, real time location services, and automatic patient placement.

12. A system for analyzing performance of a health care facility comprising:
a memory structure encoding one or more processor-executable routines, wherein the routines, when executed, cause acts to be performed comprising:
accessing performance data for a plurality of performance parameters for the health care facility;
calculating a performance value for each performance parameter of the plurality of performance parameters;
calculating an overall performance value for the healthcare facility based on all of the performance values for the plurality of performance parameters; and
providing an indication of the overall performance value; and
a processing component configured to access and execute the one or more routines encoded by the memory structure.

13. The system of claim 12, wherein providing the indication of the overall performance value comprises displaying, on a user interface of the processor-based system, an interactive indicator of the overall performance value.

14. The system of claim 13, wherein the routines, when executed by the processing component, cause further acts to be performed comprising:
comparing the overall performance value to a threshold indicative of an acceptable overall performance value, and providing an additional indication, via the interactive indicator, of whether the overall performance value is acceptable relative to the threshold.

15. The system of claim 14, wherein the interactive indicator comprises a plurality of colored zones representative of an acceptability of the overall performance value, wherein the plurality of zones comprises a first colored zone representative of an acceptable overall performance value and a second colored zone representative of an unacceptable overall performance value, and wherein the interactive indicator displays an indicator of a numerical value for the overall performance value relative to the plurality of colored zones.

16. The system of claim 13, wherein the routines, when executed by the processing component, cause further acts to be performed comprising:
receiving a selection of the interactive indicator, and in response to the selection, displaying information related to one or more of the performance parameters of the plurality of performance parameters.

17. The system of claim 16, wherein the information related to one or more of the performance parameters comprises at least one of numerical values for performance values for one or more of the performance parameters of the plurality of performance parameters, indicators for one or more of the performance parameters of the plurality of operation parameters of whether a respective performance value is acceptable relative to a threshold indicative of an acceptable performance value for the respective performance value, or one or more recommendations to improve the performance values for one or more performance parameters of the plurality of performance parameters.

18. One or more non-transitory computer-readable media encoding one or more processor-executable routines, wherein the one or more routines, when executed by a processor, cause acts to be performed comprising:
accessing performance data for a plurality of performance parameters for a health care facility;
calculating a performance value for each performance parameter of the plurality of performance parameters;
calculating an overall performance value for the healthcare facility based on all of the performance values for the plurality of performance parameters; and
providing an indication of the overall performance value.

19. The one or more non-transitory computer-readable media of claim 18, wherein providing the indication of the overall performance value comprises displaying a interactive indicator representative of the overall performance value.

20. The one or more non-transitory computer-readable media of claim 19, wherein the one or more-routines, when executed by the processor, cause further acts to be performed comprising:
receiving a selection of the interactive indicator, and in response to the selection, displaying information related to one or more of the performance parameters of the plurality of performance parameters, wherein the information related to one or more of the performance parameters comprises at least one of numerical values for performance values for one or more of the performance parameters of the plurality of performance parameters, indicators for one or more of the performance parameters of the plurality of operation parameters of whether a respective performance value is acceptable relative to a threshold indicative of an acceptable performance value for the respective performance value, or one or more recommendations to improve the performance values for one or more performance parameters of the plurality of performance parameters.
